(19) United States
(12) Patent Application Publication
(10) Pub. No.: US 2024/0338771 A1
(43) Pub. Date: Oct. 10, 2024

(54) SYSTEM AND METHOD FOR ELECTRONICALLY IDENTIFYING AND EXECUTING TERM LIFE INSURANCE POLICY EXCHANGES

(71) Applicant: Wissahickon Creek Holdings LLC, Fort Washington, PA (US)

(72) Inventor: Alan H Buerger, Fort Washington, PA (US)

(73) Assignee: Wissahickon Creek Holdings LLC, Fort Washington, PA (US)

(21) Appl. No.: 18/297,620

(22) Filed: Apr. 9, 2023

(51) Int. Cl. G06Q 40/08

(52) U.S. Cl. CPC G06Q 40/08

(57) ABSTRACT

In an embodiment, a system includes a processing device that is configured to submit a query to a database storing term life insurance policy data, to identify a plurality of candidate term life insurance policies, to select a term life insurance policy from the plurality of candidate term life insurance policies, to obtain annuity offer data comprising requirements for an offer to purchase an annuity, obtain term life insurance policy data and policy holder information, to determine that the policy holder information is a match for the requirements and to generate a proposed term life insurance policy exchange. The proposed term life insurance exchange comprises an exchange of the selected term life insurance policy for the annuity offer. The processing device is further configured to obtain approval of the proposed term life insurance policy exchange and to facilitate execution of the proposed term life insurance policy exchange.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

This application generally relates to the electronic execution of term life insurance policy exchanges, and in particular, systems and methods for electronically identifying and executing term life insurance policy exchanges.

Term life insurance policies typically have a specific term such as 5, 10 or 20 years during which a policy holder pays a premium. At the end of the term the policy expires, and the policy holder receives no additional benefit or continuing benefit for the premiums that were previously paid.

There remains a need in the art for further improvements to the disposition of term life insurance policies in a way that increases the benefits to the parties involved.

### SUMMARY

In an embodiment, a system is disclosed. The system comprises at least one processing device and at least one computer readable storage device storing data instructions that, when executed by the at least one processing device, cause the at least one processing device to submit a query to a database storing term life insurance policy data, to identify a plurality of candidate term life insurance policies based on a result of the query, and to select a term life insurance policy from the plurality of candidate term life insurance policies for offering a term life insurance policy exchange. The processing device is programmed to then obtain annuity offer data comprising requirements for an offer to purchase an annuity, obtain term life insurance policy data and policy holder information corresponding to the selected term life insurance policy, to determine that the policy holder information is a match for the requirements in the annuity offer data and to generate a proposed term life insurance policy exchange based at least in part on the determination that the policy holder information is a match for the requirements in the annuity offer data. The proposed term life insurance exchange comprises an exchange of the selected term life insurance policy for the annuity offer. The instructions further cause the at least one processing device to obtain approval of the proposed term life insurance policy exchange from the policy holder and an issuer of the annuity offer and to facilitate execution of the proposed term life insurance policy exchange.

In an embodiment, the query comprises at least one of a query for all term life insurance policies have a predetermined amount of term left, a query for all term life insurance policies have a predetermined percentage of term left, a query for all term life insurance policies having policy holders who are over a predetermined age, a query for all term life insurance policies having a predetermined amount of premiums paid and a query for all term life insurance policies having a predetermined number of premium payments.

In an embodiment, in selecting the term life insurance policy from the plurality of candidate term life insurance policies, the instructions further cause the at least one processing device to assess the plurality of candidate term life insurance policies based on predetermined criteria. The predetermined criteria comprises at least one of a total term of a candidate term life insurance policy, a remaining term of a candidate term life insurance policy, an amount of premiums paid into a candidate term life insurance policy, a percentage of an amount of premiums paid into a term life insurance policy relative to a total amount of premiums that would be paid by an end date of the term life insurance policy, an age of the policy holder and an age that the policy holder would be at the end date of the term life insurance policy.

In an embodiment, the proposed term life insurance policy exchange comprises an assignment of the term life insurance policy and a transfer of a cost basis of the term life insurance policy to the annuity.

In an embodiment, in obtaining approval of the proposed term life insurance policy exchange from the policy holder and an issuer of the annuity offer, the instruction further cause the at least one processing device to provide the proposed term life insurance policy exchange to a client device associated with the policy holder, to receive, from the client device associated with the policy holder, an indication to request approval from the issuer of the annuity offer, to provide the term life insurance policy data and the policy holder information corresponding to the selected term life insurance policy and the proposed term life insurance policy to a server associated with the issuer of the annuity offer, to receive, from the server associated with the issuer of the annuity offer, an approval of the proposed term life insurance policy exchange, to provide the approved term life insurance policy exchange to the client device associated with the policy holder and to receive, from the client device associated with the policy holder, an endorsement of the approved term life insurance policy exchange.

In an embodiment, in facilitating the execution of the proposed term life insurance policy exchange, the instructions further cause the at least one processing device to interface with a server associated with an issuer of the selected term life insurance policy, to cause a transfer of the selected term life insurance policy from the issuer of the selected term life insurance policy to the issuer of the annuity offer, to interface with a server associated with the issuer of the annuity offer, to confirm the transfer of the selected term life insurance policy from the issuer of the selected term life insurance policy to the issuer of the annuity offer and to cause the server associated with the issuer of the annuity offer to execute the term life insurance policy exchange.

In an embodiment, in facilitating the execution of the proposed term life insurance policy exchange, the instructions further cause the at least one processing device to interface with a server associated with an issuer of the selected term life insurance policy, to cause a transfer of the selected term life insurance policy from the issuer of the selected term life insurance policy to an entity associated with the system and to generate an annuity according to the approved term life insurance policy exchange. The annuity comprises an annuity premium paid by the policy holder and a cost basis transferred from the selected term life insurance policy. The instructions further cause the at least one processing device to execute an assignment of the selected term life insurance policy.

In an embodiment, the instructions further cause the at least one processing device to interface with a server associated with the issuer of the annuity offer and transfer the generated annuity to the issuer of the annuity offer via the interface with the server associated with the issuer of the annuity offer.

In an embodiment, the instructions further cause the at least one processing device to determine an amount of a fee based on, e.g., at least one of a percentage of a cost basis that is transferred from the selected term life insurance policy to the annuity as part of the term life insurance policy exchange and a percentage of an annuity premium payment being made into the annuity.

In an embodiment, a method performed by at least one processor comprising hardware is disclosed. The method comprises submitting a query to a database storing term life insurance policy data, identifying a plurality of candidate term life insurance policies based on a result of the query, selecting a term life insurance policy from the plurality of candidate term life insurance policies for offering a term life insurance policy exchange, obtaining annuity offer data comprising requirements for an offer to purchase an annuity, obtaining term life insurance policy data and policy holder information corresponding to the selected term life insurance policy, determining that the policy holder information is a match for the requirements in the annuity offer data and generating a proposed term life insurance policy exchange based at least in part on the determination that the policy holder information is a match for the requirements in the annuity offer data. The proposed term life insurance exchange comprises an exchange of the selected term life insurance policy for the annuity offer. The method further comprises obtaining approval of the proposed term life insurance policy exchange from the policy holder and an issuer of the annuity offer and facilitating execution of the proposed term life insurance policy exchange.

In an embodiment, a non-transitory computer-readable medium is disclosed. The non-transitory computer-readable medium stores instructions that, when executed by at least one processor, cause the at least one processor to submit a query to a database storing term life insurance policy data, to identify a plurality of candidate term life insurance policies based on a result of the query, to select a term life insurance policy from the plurality of candidate term life insurance policies for offering a term life insurance policy exchange, to obtain annuity offer data comprising requirements for an offer to purchase an annuity, to obtain term life insurance policy data and policy holder information corresponding to the selected term life insurance policy, to determine that the policy holder information is a match for the requirements in the annuity offer data and to generate a proposed term life insurance policy exchange based at least in part on the determination that the policy holder information is a match for the requirements in the annuity offer data. The proposed term life insurance exchange comprises an exchange of the selected term life insurance policy for the annuity offer. The instructions further cause the at least one processor to obtain approval of the proposed term life insurance policy exchange from the policy holder and an issuer of the annuity offer and facilitate execution of the proposed term life insurance policy exchange.

The foregoing summary is illustrative only and is not intended to be in any way limiting. These and other illustrative embodiments include, without limitation, apparatus, systems, methods and computer-readable storage media. In addition to the illustrative aspects, embodiments, and features described above, further aspects, embodiments, and features will become apparent by reference to the drawings and the following detailed description.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 is a block diagram of a system according to an embodiment.

FIG. 2 is a block diagram of an example server of the system of FIG. 1 according to an embodiment.

FIG. 3 is a flow diagram of an example process using the system of FIG. 1 to facilitate a term life insurance policy exchange according to an embodiment.

### DETAILED DESCRIPTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the illustrative embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

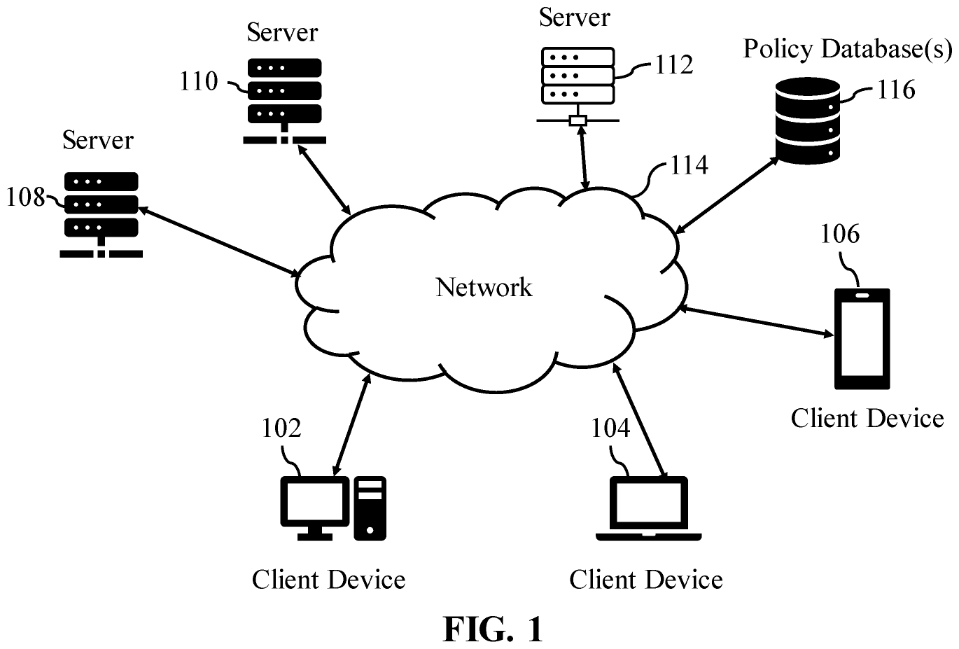

FIG. 1 presents a computing system 100 according to an embodiment. Computing system 100 includes one or more client devices 102, 104, 106 that communicate with one or more servers 108, 110, 112 to conduct term life insurance policy exchanges through network 114. The servers 108, 110, 112 may also communicate with each other to facilitate the performance of the term life insurance policy exchanges. Servers 108, 110, 112 may also communicate with one or more policy database(s) 116 to obtain data associated with life insurance policies and annuities.

Client devices 102, 104 and 106 may comprise computing devices (e.g., desktop computers, terminals, laptops, personal digital assistants (PDA), cellular phones, smartphones, tablet computers, or any computing device having a central processing unit and memory unit capable of connecting to a network). Client devices may also comprise a graphical user interface (GUI) or a browser application provided on a display (e.g., monitor screen, LCD or LED display, projector, etc.). A client device may also include or execute an application to communicate content, such as, for example, textual content, multimedia content, or the like. A client device may also include or execute an application to perform a variety of possible tasks, such as browsing, searching, communicating or any other tasks. Client devices may include or execute a variety of operating systems, including a personal computer operating system, such as Windows, Mac OS or Linux, a mobile operating system, such as iOS, Android, or Windows Phone, or any other operating system. A client device may include or may execute a variety of possible applications, such as a client software application enabling communication with other devices, such as communicating one or more messages, such as via email, short message service (SMS), or multimedia message service (MMS).

Servers 108, 110 and 112, as described herein, may comprise at least a special-purpose digital computing device including at least one or more central processing units and memory. A server may also include one or more of mass storage devices, power supplies, wired or wireless network interfaces, input/output interfaces, and operating systems, such as Windows Server, Mac OS X, Unix, Linux, FreeBSD, or the like. In an example embodiment, a server may include or have access to memory or computer readable storage devices for storing instructions or applications for the performance of various functions and a corresponding processor for executing stored instructions or applications. For example, the memory may store an instance of the server configured to operate in accordance with the disclosed embodiments.

Network 114 may be any suitable type of network allowing transport of data communications across thereof. Network 114 may couple devices so that communications may be exchanged, such as between servers and client devices or other types of devices, including between wireless devices coupled via a wireless network, for example. A network may also include mass storage, such as network attached storage (NAS), a storage area network (SAN), cloud computing and storage, or other forms of computer or machine-readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from client devices and servers may be encrypted using, for example, the Advanced Encryption Standard (AES) with a 128, 192, or 256-bit key size, or any other encryption standard known in the art.

Policy database(s) 116 may comprise data storage systems including hard disk drives (HDD), solid state drives (SSDs) or other storage technologies. In some embodiments, the data storage devices may be implemented using non-volatile memory (NVM) devices such as flash memory. Other types of NVM devices that can be used to implement at least a portion of the data storage devices include non-volatile random access memory (NVRAM), phase-change RAM (PC-RAM) and magnetic RAM (MRAM). These and various combinations of multiple different types of NVM devices may also be used. The particular storage devices used may be varied in other embodiments, and multiple distinct storage device types may be used within a data storage system.

Example data storage systems that may be utilized by policy database(s) 116 include network-attached storage (NAS), storage area networks (SANs), direct-attached storage (DAS), distributed DAS, cloud-based computing and storage as well as combinations of these and other storage types, including software-defined storage. Other types of data storage systems that can be used including all-flash and hybrid flash storage arrays, software-defined storage systems, cloud storage systems, object-based storage systems, and scale-out NAS clusters and associated accelerators. Combinations of multiple ones of these and other data storage systems can also be used in implementing a policy database(s) 116 in an illustrative embodiment.

Policy database(s) 116 may store data associated with life insurance policies or annuities issued by issuing entities associated with servers 108 and 110. For example, a first issuing entity may be associated with server 108 and a second issuing entity may be associated with server 110. In some embodiments, the first issuing entity may issue life insurance policies to policy holders, e.g., including term life insurance policies, while the second issuing entity may issue annuities to policy holders. In other embodiments, either of the first and second issuing entities may issue life insurance policies, annuities or both to policy holders. Data associated with any life insurance policies or annuities issued by the first and second issuing entities may be stored on policy database(s) 116.

In some embodiments, each of servers 108, 110 and 112 may also or alternatively comprise its own policy database 116. As an example, server 108 may store data associated with life insurance policies, annuities or both issued by the first issuing entity while server 110 may store data associated with life insurance policies, annuities or both issued by the second issuing entity. In some embodiments, the first and second issuing entities may issue other insurance agreements including, e.g., endowment contracts and long-term care insurance contracts.

An exchange entity associated with server 112 may facility an exchange of life insurance policies and annuities between the first and second issuing entities based on the data stored on servers 108 and 110, on policy database(s) 116 or both. Example data that may be stored for life insurance policies may include, for example, a type of the life insurance policy, e.g., term, whole life, etc., a term of the life insurance policy or date of expiration if any, a premium paid by the policy holder of the life insurance policy, policy holder information such as, e.g., name, age, date of birth, address, contact information, or any other information about the policy holder that may be relevant to an issued policy or an exchange of the policy. Various details about annuities, endowment contracts and long-term care insurance contracts may also be stored.

Term life insurance policies typically define a specific term for the policy such as 5 years, 10 years or 20 years. If an event occurs during the term that triggers a payout of the policy, e.g., a death of the policy holder, the policy holder or other beneficiary receives the death benefit based on the terms of the policy. During the term of the policy, the policy holder also pays a premium, e.g., a single up-front payment, a series of payments monthly or annually, or according to another schedule. With each premium payment, the policy holder increases the cost basis for the policy where the cost basis comprises the total amount of premiums paid into the policy. Other payments or factors may also contribute to the cost basis.

If no event occurs that triggers a payout on the policy, then at the end of the term, the term life insurance policy typically expires, and the policy holder receives no further or additional benefit. Any cost basis that the policy holder has accrued during the term of the term life insurance policy through premium payments or other factors is typically lost when the term ends and the policy expires. In addition, the cost basis also is lost if the policy holder surrenders the term policy during the term or the term policy lapses.

An annuity is a contract with an insurance company under which a policy holder makes a lump-sum payment or series of payments, and, in return, the insurer agrees to make periodic payments to the policy holder beginning immediately or at some future date. Annuities typically offer tax-deferred growth of earnings and may include a death benefit that will pay a beneficiary a specified minimum amount, such as the total purchase payments. While tax is deferred on earnings growth, when withdrawals are taken from the annuity, gains are taxed at ordinary income rates, and not capital gains rates. If a policy holder withdraws their money early from an annuity, they may pay substantial surrender charges to the insurance company, as well as tax penalties.

When a policy holder begins receiving payouts from an annuity, a portion of each payment is not subject to income tax because it is considered a return of the policy holder's principal. This portion is determined by the exclusion ratio. The exclusion ratio is typically calculated by dividing the premium by the expected return on the annuity. The expected return is calculated by multiplying the payout benefit, e.g., as defined in the annuity contract, by the specified life expectancy of the policy holder. Any expected return above the annuity's exclusion ratio is subject to taxation. An example equation for calculating an exclusion ratio is provided below as equation (1):

$$Exclusion ratio \% = \frac{Premium}{Expected Return} \qquad ( 1 )$$

The premium is the amount that the policy holder pays into the annuity, e.g., as a lump-sum or in payments over a period of time.

The expected return is the benefit is the amount of payout that the policy holder receives in each payment multiplied by the life-expectancy period, e.g., number of payments corresponding to the life expectancy of the policy holder as specified in the annuity contract. For example, the expected return may be calculated according to equation (2):

$$Expected Return = Benefit \times Life Expectancy Period \qquad ( 2 )$$

In an example, if a policy holder pays a lump-sum premium of $200,000 and receives a monthly benefit of $1200 for a 20-year life expectancy, the expected return according to equation (2) is $1,200×240=$288,000 and the exclusion ratio according to equation (1) is

$$\frac{\$200 , 000}{\$288 , 000} = 69.4 \% .$$

The exclusion ratio of 69.4% is then applied to the benefit of $1200 for a tax free portion of $832.80 and a taxable portion of $367.20.

Example term life insurance policy exchanges that may be implemented by computing system 100 include an exchange of an existing term life insurance policy for a new life insurance policy, an exchange of an existing term life insurance policy to supplement an existing life insurance policy, an exchange of an existing term life insurance policy for a new annuity and an exchange of an existing term life insurance policy to supplement an existing annuity. In some embodiments, the existing term life insurance policy may be exchanged for more than one new life insurance policy or annuity or exchanged to supplement more than one existing life insurance policy or annuity. In some embodiments, multiple term life insurance policies may be exchanged together for one or more new life insurance policies or annuities or exchanged together to supplement one or more existing life insurance policies or annuities. In some embodiments, the term life insurance policy may be exchanged for a new endowment contract, to supplement an existing endowment contract, for a new long-term care insurance contract or to supplement an existing longer-term care insurance contract. The exchange of the term life insurance policy for a new life insurance policy, annuity, endowment contract or long-term care insurance contract or to supplement an existing life insurance policy, annuity, endowment contract or long-term care insurance contract may qualify as a section 1035 exchange under the Internal Revenue Service Code. While example term life insurance policy exchanges will be described in more detail herein for exchanges of term life insurance policies for new or existing annuities, it is understood that the term life insurance policy exchanges may also be performed in a similar manner for exchanging term life insurance policies for new or existing life insurance policies, endowment contracts and long-term care insurance contracts without departing from the scope of the present disclosure.

A term life insurance policy exchange provides a policy holder with an opportunity to capture the cost basis from premiums paid in the term life insurance policy that would otherwise be lost at the expiration of the term of the policy or earlier lapse or surrender. For example, an exchange of a term life insurance policy for a new annuity or to supplement an existing annuity may preserve and transfer the existing cost basis of the premium payments made in the term life insurance policy to the cost basis of the annuity that is the target of the exchange. As an example, if a policy holder had a 20-year term life insurance policy and paid a premium of $100 a month for the full 20 years of the policy, the policy holder would have accrued a cost basis of $24,000 which is lost at the expiration of the policy. If the policy holder exchanges the term life insurance policy for a new annuity prior to expiration, for example, at 15 years, the cost basis of the term life insurance policy would be $18,000 at the time of exchange. This cost basis from the term life insurance policy may then be added to the cost basis of the new annuity. For example, if the policy holder purchases a single premium annuity for a $100,000 premium as part of the exchange, the cost basis of the annuity is now $118,000, i.e., $100,000 for the annuity premium and $18,000 for the premiums from the exchanged cost basis from the term life insurance policy.

This increased cost basis may now be utilized for any distributions in the annuity including withdrawals and regular annuity payments. For example, any withdrawals from the annuity will be treated using the combined cost basis of $118,000 instead of the original annuity cost basis of $100,000. For regular annuity payments, the combined cost basis of $118,000 will be used as the premium portion of the exclusion ratio where, for example, the premium amount in the exclusion ratio would be $118,000 instead of $100,000, increasing the tax-free portion of any payments made under the annuity.

In a first example scenario, John is a 75-year-old policy holder who purchased a $1,000,000 term life insurance policy 11 years ago. John has paid $25,000 in premiums on the term life insurance policy and the policy has no cash value. John exchanges his term life insurance policy for a deferred annuity using a term life insurance policy exchange as described above and also makes a $100,000 annuity premium payment giving the annuity an initial cash value of $100,000 and a cost basis and investment value of $125,000. The annuity payment starting date is five years after the exchange. After three years, the cash value of the annuity contract has increased to $120,000, e.g., due to investment growth, interest, etc., and John decides to withdraw $20,000.

In this scenario, John's investment amount in the annuity contract is the $125,000 combined cost basis, i.e., the $100,000 annuity premium payment and the $25,000 in premiums transferred from the term life insurance policy in the term life insurance policy exchange. Because John receives a $20,000 distribution prior to the annuity starting date, under the last in, first out (LIFO) rule it will first be treated as gross income to the extent the cash value of the annuity exceeds John's investment amount in the annuity. The balance of the withdrawal will then be treated as a nontaxable return of capital.

As an example, if John had acquired the annuity for the $100,000 annuity premium and not executed the term life insurance policy exchange using his term life insurance policy, his investment amount would have been $100,000 for tax purposes. Since the cash value of the annuity increased in value to $120,000, the first $20,000 to be withdrawn is treated as exceeding his investment amount of $100,000. In this case, John's entire withdrawal would be taxable as gross income and may also be subject to the 10% penalty tax on premature withdrawals. In a case where the cash value had only increased to $110,000, the first $10,000 of the withdrawal would be treated as exceeding the investment amount of $100,000 and be taxable as gross income while the second $10,000 of the withdrawal would be treated as a nontaxable return of capital.

In the first example scenario, since John acquired the annuity using the term life insurance policy exchange, his investment amount in the annuity is considered to be $125,000 for tax purposes. Since the cash value of the annuity is $120,000 is still less than the $125,000 investment amount, John's withdrawal of $20,000 from the annuity will be treated entirely as a nontaxable return of capital. To the extent the distribution is treated as a return of capital, John's investment amount in the annuity will be reduced, e.g., from $125,000 to $105,000. In addition, because the whole withdrawal is treated as a return of capital and no portion of the withdrawal is treated as gross income, no portion of the withdrawal is subject to the 10% penalty tax for premature withdrawals.

In a second example scenario, Jane is a 65-year-old policy holder who purchased a $1,000,000 term life insurance policy 20 years ago. Jane has paid $30,000 in premiums into the policy and the policy has no cash value. Jane executes a term life insurance policy exchange of her term life insurance policy for a deferred annuity and makes an $80,000 annuity premium payment. Jane then receives her annuity payments as scheduled under the annuity.

In this scenario, Jane's tax basis in the annuity is $110,000, i.e., $80,000 from the annuity premium payment and $30,000 from the premiums previously paid in the term life insurance policy. Jane's investment amount in the annuity is also $110,000 for the purposes of taxation although the cash value is $80,000 to start. Because of the term life insurance policy exchange, the numerator of the exclusion ratio from equation (1) will be $110,000, which is $30,000 higher than it would have been had Jane not utilized the term life insurance policy exchange. As a result, the proportion of each annuity payment that is treated as a nontaxable return of capital under the exclusion ratio is higher than if the term life insurance policy exchange was not executed.

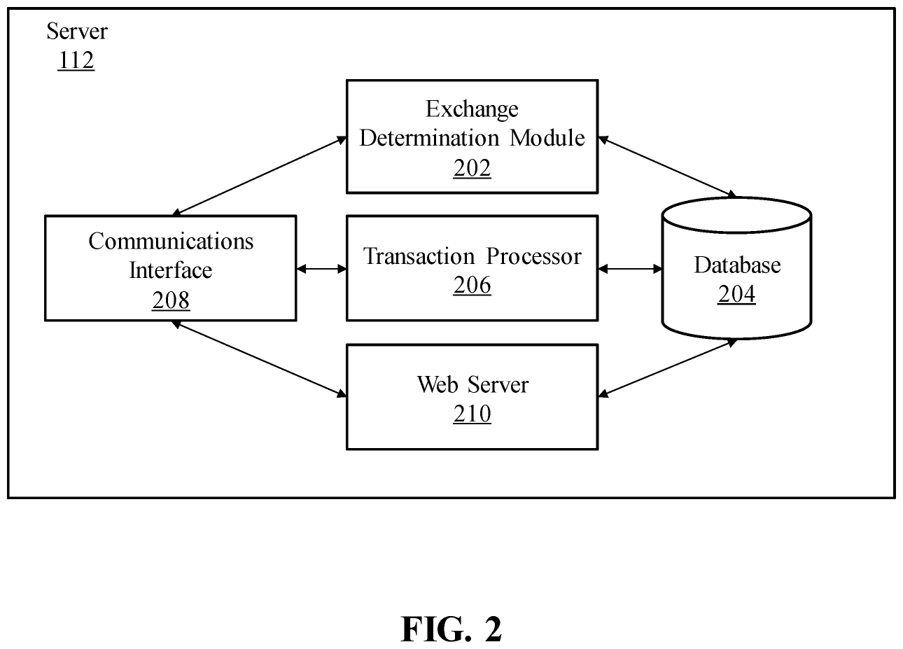

With reference to FIG. 2, server 112 comprises an exchange determination module 202, a database 204, an exchange processor 206, a communication interface 208 and a web interface 210. In some embodiments, client devices 102, 104 and 106 and servers 108 and 110 may communicate with server 112 by connecting with web server 210 through communication interface 208. Web server 210 may service requests from the client devices and servers over a network communication. Web server 210 may access data stored in database 204. Database 204 may store user profiles of parties including contact information, certifications (e.g., licensing information) or other information. Database 204 may be implemented with a group of networked server computers or other storage devices. Web server 210 may authenticate client devices and servers based on information stored in database 204.

Exchange determination module 202 is configured to identify and select candidate term life insurance policies on which to perform a term life insurance policy exchange. Exchange determination module 202 is configured to integrate and communicate with one or more of server 108, server 110 and policy database(s) 116, e.g., via communications interface 208.

In some embodiments, for example, exchange determination module 202 may be configured to submit one or more queries to search, filter or otherwise parse term life insurance policy data stored on one or more of server 108, server 110 and policy database(s) 116 to identify candidate term life insurance policies for performing a term life insurance policy exchange according to the embodiments described herein. For example, exchange determination module 202 may be configured to submit Structured Query Language (SQL) or other database queries of policy database(s) 116 or databases stored on server 108, 110 to identify candidate term life insurance policies. Exchange determination module 202 may receive data comprising a result of the query, e.g., a list of candidate term life insurance policies meeting the search criteria, from server 108, 110 or policy database(s) 116.

Example queries that may be submitted by exchange determination module 202 include, e.g., a query for all term life insurance policies having a predetermined amount of term left, e.g., 1 year, 2 years, 3 years, 4 years, 5 years, or any other remaining term, a query for all term life insurance policies have a predetermined percentage of term left, e.g., 5% term left, 10% term left, 15% term left, 20% term left or any other percentage of term left, a query for all term life insurance policies having policy holders that are over a predetermined age, e.g., 50, 55, 60, 65, 70, 75, or any other age, a query for all term life insurance policies having a predetermined amount of premiums paid or number of premium payments, a query for any other details of a term life insurance policy or any combination thereof.

Exchange determination module 202 may also or alternatively obtain term the life insurance policy data from servers 108, 110 or policy database(s) 116 and store the term life insurance policy data on database 204 for querying locally on server 112 in the manner as described above.

In some embodiments, a policy holder may separately communicate with exchange determination module 202, e.g., via web interface 210, to present their term life insurance policy for consideration and addition to the list of candidate term life insurance policies. For example, the policy holder may have seen an advertisement for performing the term life insurance policy exchange or be referred to the web interface 210 in another manner.

Exchange determination module 202 is further configured to select one or more term life insurance policies from the obtained list of candidate term life insurance policies for offering a term life insurance policy exchange. In some embodiments, the selection may be performed automatically by exchange determination module 202, e.g., using an algorithm that assesses each candidate term life insurance policy based on a predetermined set of criteria. Example criteria may include total term of the term life insurance policy, remaining term of the term life insurance policy, percentage of remaining term of the term life insurance policy, amount of premiums paid into the term life insurance policy, percentage of the amount of premiums paid into the term life insurance policy relative to the total amount of premiums paid into the term life insurance policy if premiums were to be paid until the end of the term life insurance policy, age of the policy holder, age that the policy holder will be at the end of the term of the term life insurance policy, any other details about the term life insurance policy or any combination thereof. In some embodiments, exchange determination module 202 may be configured to weight the criteria for selecting a term life insurance policy for a term life insurance policy exchange.

Exchange determination module 204 may calculate a cost basis for each candidate term life insurance policy. For example, the term life insurance policy data for each candidate term life insurance policy may comprise a premium payment amount or schedule, a start date of the policy, a total number of premium payments made, a total amount of premium payments made or any other information. Exchange determination module 204 may determine the cost basis for a candidate term life insurance policy, e.g., by obtaining or otherwise calculating the total value of premium payments made by the policy holder to the issuer for the candidate term life insurance policy based on the available information in the corresponding term life insurance policy data. Exchange determination module 204 may then select a candidate term life insurance policy for offering a term life insurance policy exchanged based on the determined cost basis. As an example, exchange determination module 204 may determine whether or not to select the candidate term life insurance policy for a term life insurance policy exchange based on a comparison of the determined cost basis to a predetermined minimum cost basis threshold, e.g., candidate term life insurance policies having a determined cost basis greater than the predetermined minimum cost basis threshold may be considered for selection assuming any other criteria are also met.

In some embodiments, a user of a client device 102, 104, 106 may also or alternatively perform a selection, e.g., by logging into web server 210, studying the list of candidate term life insurance policies, and selecting one or more of the candidate term life insurance policies for offering a term life insurance policy exchange. In some embodiments, exchange determination module 202 may automatically select some candidate term life insurance policies and may flag other candidate term life insurance policies for further review by a user.

Exchange determination module 204 provides the list of selected term life insurance policies to transaction processor 206. Transaction processor 206 is configured to generate term life insurance policy exchange transactions and to execute the term life insurance policy exchange transactions. For example, transaction processor 206 may obtain the term life insurance policy data and policy holder information for each selected term life insurance policy, e.g., from the corresponding server 108, 110, from policy database(s) 116 or from database 204. The policy holder information may include, e.g., contact information, age or any other information that may be relevant to offering an annuity to the policy holder. Transaction processor 206 may also obtain information or other data regarding potential annuity offers that may match the obtained policy holder information, e.g., from the servers 108 and 110, depending on which of the first and second issuing entities is offering annuities.

As an example, transaction processor 206 accesses the term life insurance policy data and policy holder information for a selected term life insurance policy for matching the policy holder to an annuity offer. Transaction processor 206 matches the policy holder to the annuity offer and generates a proposed term life insurance policy exchange transaction for exchanging the term life insurance policy for the annuity. Transaction processor 206 presents the generated proposed term life insurance policy exchange to the policy holder, e.g., via a communication between transaction processor 206 and a corresponding computing device 102, 104, 106 of the policy holder, e.g., via communications interface 208 and network 114. In some embodiments, transaction processor 206 may alternatively present the policy holder with an invitation or link to log into web server 210 and review the proposed term life insurance policy exchange.

If the policy holder is interested in the proposed term life insurance policy exchange, an indication that the policy holder would like to proceed may be obtained by transaction processor 206 from the corresponding client device 102, 104, 106, e.g., via network 114 and communication interface 208. In the case where the policy holder has logged into web interface 210, the indication may be received by transaction processor 206 from web interface 210. In some embodiments, receipt of the indication by transaction processor 206 may trigger an approval process, e.g., with an underwriter of the corresponding entity that is offering the annuity. For example, transaction processor 206 may forward one or more of the proposed term life insurance policy exchange, policy holder information and corresponding term life insurance data to the entity that is offering the annuity, e.g., to the corresponding server 108 or 110. In an embodiment, where the same entity is both the issuer of the term life insurance policy and offering the annuity, transaction processor 206 may only need to provide a subset of the data, e.g., just the proposed term life insurance policy exchange in some embodiments, since that entity already stores the remaining data about the policy holder information and term life insurance data.

Transaction processor 206 is configured to receive an approval of the proposed term life insurance policy exchange from the entity offering the annuity, e.g., from the server 108, 110 corresponding to the entity offering the annuity. Transaction processor 206 is configured to present the documentation for the approved term life insurance policy exchange to the policy holder for approval by the policy holder, e.g., to the corresponding client device 102, 104, 106 via communication interface or to web interface 210 for access by the policy holder. Transaction processor 206 is configured to receive an indication of approval of the term life insurance policy exchange from the policy holder, e.g., from the corresponding client device 102, 104, 106 via communication interface or from web interface 210. The indication of approval by the policy holder may comprise, for example, a signature or other endorsement on the documentation, an electronic signature or endorsement, or any other manner of indicating approval of the proposed term life insurance policy exchange.

In some embodiments, transaction processor 206 is configured to facilitate a transfer of the term life insurance policy to the offeror of the annuity before facilitating an execution of the term life insurance policy exchange. For example, transaction processor 206 may interface with both the issuer of the term life insurance policy and the offeror of the annuity to transfer the term life insurance policy to the offeror of the annuity if needed. This transfer may occur before or after the policy holder has indicated approval of the proposed term life insurance policy exchange. In one example, if the first issuing entity associated with server 108 is the issuer of the term life insurance policy and the second issuing entity associated with server 110 is the offeror of the annuity, transaction processor 206 may facilitate a transfer of the term life insurance policy to the second issuing entity before the exchange is processed, e.g., by communicating with server 108 to initiate or facilitate the transfer, communicating with server 110 to confirm or otherwise facilitate the transfer, or in any other manner. In other embodiments, the term life insurance policy exchange may be executed without transferring the term life insurance policy to the issuing entity making the annuity offer.

Transaction processor 206 is further configured to provide the issuing entity making the annuity offer with the indication of approval of the term life insurance policy exchange received from the policy holder, e.g., to the corresponding server 108, 110 via communication interface 208. Transaction processor 206 may interface with the corresponding server 108, 110 to facilitate execution of the term life insurance policy exchange.

In some embodiments, transaction processor may perform the execution of the term life insurance policy exchange on server 112, e.g., by generating the new annuity and executing an assignment of the term life insurance policy on behalf of the policy holder, and subsequently transfer the new annuity to the entity that offered the annuity. In such an embodiment, transaction processor 206 may facilitate a transfer of the term life insurance policy to an entity associated with server 112.

As part of facilitating the term life insurance policy exchange, transaction processor 206 may also determine an amount for a fee or commission. In some embodiments, for example, transaction processor 206 may determine the amount as a percentage of the cost basis being transferred. In some embodiments, transaction processor 206 may determine the amount as a percentage of any annuity premium payment being made into the new annuity as part of the term life insurance policy exchange. In other embodiments, any other method of determining a fee or commission for facilitating the term life insurance exchange may be utilized. The fee or commission may be paid by the policy holder, the offeror of the annuity or any other entity.

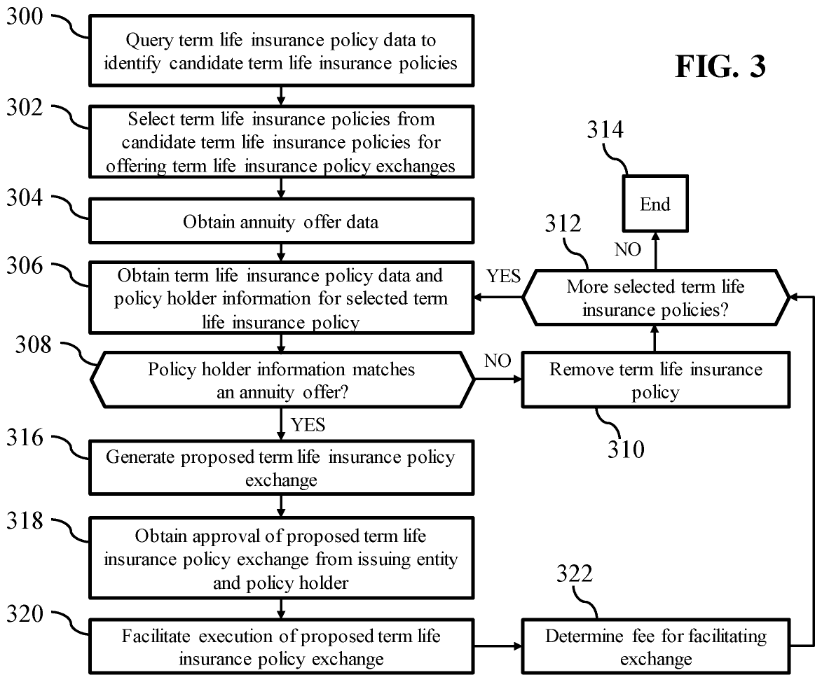

With reference to FIG. 3, an example process of using system 100 to facilitate a term life insurance policy exchange will now be described. The process of FIG. 3 comprises steps 300 through 320.

Initially, one or more of servers 108, 110 and policy database(s) 116 may store term life insurance policy data associated with term life insurance policies that have been issued to policy holders. As an example, server 108 or a corresponding policy database 116 may store term life insurance policy data for term life insurance policies issued by the first issuing entity, while server 110 or a corresponding policy database 116 may store term life insurance policy data for term life insurance policies issued by the second issuing entity.

At step 300, exchange determination module 202 of server 112 performs one or more queries on term life insurance policy data stored on server 108, server 110, policy database 116 or database 204 to identify candidate term life insurance policies. For example, exchange determination module 202 comprises one or more programs that implement or execute functionality for interfacing with databases stored on server 108, server 110, policy database(s) 116 and database 204, to query term life insurance policy data based on predetermined criteria as described above. In some embodiments, for example, the term life insurance policy data to be queried may be stored on server 108, server 110 or policy database(s) 116 and a query may be submitted to server 108, server 110 or policy database(s) 116 by exchange determination module 202 via communication interface 208 to identify candidate term life insurance policies issued by one or more of the first and second issuing entities in the manner described above. In some embodiments, exchange determination module 202 may obtain term life insurance policy data from one or more of server 108, server 110 or policy database(s) 116, store the obtained term life insurance policy data on server 112, e.g., in database 204, and query the term life insurance policy data stored in database 204 to identify the candidate term life insurance policies. In some embodiments, a list of candidate term life insurance policies may be returned to exchange determination module 202 based on the queries. In some embodiments, a policy holder may separately communicate with exchange determination module 202, e.g., via web interface 210, to present their term life insurance policy for consideration and addition to the list of candidate term life insurance policies.

At step 302, exchange determination module 202 selects term life insurance policies from the candidate term life insurance policies for offering term life insurance policy exchanges, for example, in the manner described above. For example, exchange determination module 202 may execute an algorithm or other code that is configured to select term life insurance policies from the candidate term life insurance policies based on a set of criteria, based on user input, or in any other manner. In some embodiments, exchange determination module 202 may automatically select the term life insurance policies from the candidate term life insurance policies. In other embodiments, exchange determination module 202 may automatically select some of the candidate term life insurance policies and may flag other candidate term life insurance policies for further review, e.g., by a human user. In some embodiments, those candidate term life insurance policies not selected or flagged by exchange determination module 202 may be removed from consideration.

At step 304, transaction processor 206 of system 212 obtains annuity offer data. For example, transaction processor 206 may obtain annuity offer data from one of servers 108 and 110 based on which of the first and second issuing entities is offer annuities.

At step 306, transaction processor 206 obtains term life insurance policy data and policy holder information for each of the term life insurance policies selected by exchange determination module 202, e.g., from the server 108, 110, policy database(s) 116 or database 204 that stores data about that term life insurance policy and policy holder.

At step 308, transaction processor 206 determines whether or not the policy holder information for a selected term life insurance policy matches an annuity offer. For example, the annuity offer data may comprise an indication of particular requirements or other data that determine whether or not a policy holder may qualify for a particular annuity offer. Transaction processor 206 analyzes the policy holder information to determine whether or not the policy holder meets the requirements for an annuity offer.

At step 310, if the policy holder information of the policy holder of the selected term life insurance policy does not match any annuity offers, the process proceeds to step 310 and transaction processor 206 removes the selected term life insurance policy, e.g., from the list of selected term policy holders, from the list of candidate term policy holders, or both.

At step 312, transaction processor 206 determines whether there are more selected term life insurance policies to process. If there are no more selected term life insurance policies to process, the process ends at step 314. If there are more selected term life insurance policies to process, the process returns to step 306 and transaction processor 206 obtains the term life insurance policy data and policy holder information corresponding to the next selected term life insurance policy.

Referring back to step 308, if transaction processor 206 determines that the policy holder matches an annuity offer, the process proceeds to step 316.

At stem 316, transaction processor 206 generates a proposed term life insurance policy exchange for exchanging the selected term life insurance policy for the annuity offer.

At step 318, transaction processor 206 obtains approval of the proposed term life insurance policy exchange from the issuing entity that offered the annuity and from the policy holder. As an example, transaction processor 206 may provide the proposed term life insurance policy exchange to the policy holder, receive an indication of interest by the policy holder, provide the proposed term life insurance policy exchange to the issuing entity, receive approval from the issuing entity underwriters (which may adjust some terms of the proposal), and obtain final approval from the policy holder in the manner described above.

At step 320, transaction processor 206 facilitates execution of the proposed term life insurance policy exchange and determines the corresponding fee or commission at step 322, e.g., in the manner described above. In some embodiments, steps 320 and 322 may be combined or reversed in order. The process then returns to step 312 and transaction processor 206 determines whether or not there are any other selected term life insurance policies to be processed.

The particular processing operations and other system functionality described in conjunction with the flow diagram of FIG. 3 are presented by way of illustrative example only and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement the disclosed embodiments.

Functionality such as that described in conjunction with the process of FIG. 3 may be implemented at least in part in the form of one or more software programs stored in memory and executed by a processor of a processing device such as a computer or server. As will be described herein, a memory or other storage device having executable program code of one or more software programs embodied therein is an example of what is more generally referred to herein as a “processor-readable storage medium.”

FIGS. 1 through 3 are conceptual illustrations allowing for an explanation of the disclosed embodiments of the invention. Notably, the figures and examples above are not meant to limit the scope of the invention to a single embodiment, as other embodiments are possible by way of interchange of some or all of the described or illustrated elements. Moreover, where certain elements of the disclosed embodiments can be partially or fully implemented using known components, only those portions of such known components that are necessary for an understanding of the disclosed embodiments are described, and detailed descriptions of other portions of such known components are omitted so as not to obscure the disclosed embodiments. In the present specification, an embodiment showing a singular component should not necessarily be limited to other embodiments including a plurality of the same component, and vice-versa, unless explicitly stated otherwise herein. Moreover, terms in the specification or claims are not intended to be ascribed an uncommon or special meaning unless explicitly set forth as such. Further, the disclosed embodiments encompass present and future known equivalents to the known components referred to herein by way of illustration.

It should be understood that the various aspects of the embodiments could be implemented in hardware, firmware, software, or combinations thereof. In such embodiments, the various components and/or steps would be implemented in hardware, firmware, and/or software to perform the functions of the disclosed embodiments. That is, the same piece or different pieces of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description will so fully reveal the general nature of the disclosed embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

What is claimed is:

1. A system comprising:
at least one processing device; and
at least one computer readable storage device storing data instructions that, when executed by the at least one processing device, cause the at least one processing device to:
submit a query to a database storing term life insurance policy data;
identify a plurality of candidate term life insurance policies based on a result of the query;
select a term life insurance policy from the plurality of candidate term life insurance policies for offering a term life insurance policy exchange;
obtain annuity offer data comprising requirements for an offer to purchase an annuity;
obtain term life insurance policy data and policy holder information corresponding to the selected term life insurance policy;
determine that the policy holder information is a match for the requirements in the annuity offer data;
generate a proposed term life insurance policy exchange based at least in part on the determination that the policy holder information is a match for the requirements in the annuity offer data, the proposed term life insurance exchange comprising an exchange of the selected term life insurance policy for the annuity offer;
obtain approval of the proposed term life insurance policy exchange from the policy holder and an issuer of the annuity offer; and
facilitate execution of the proposed term life insurance policy exchange.

2. The system of claim 1, wherein the query comprises at least one of:
a query for all term life insurance policies have a predetermined amount of term left;
a query for all term life insurance policies have a predetermined percentage of term left;
a query for all term life insurance policies having policy holders who are over a predetermined age;
a query for all term life insurance policies having a predetermined amount of premiums paid; and
a query for all term life insurance policies having a predetermined number of premium payments.

3. The system of claim 1 wherein in selecting the term life insurance policy from the plurality of candidate term life insurance policies, the instructions further cause the at least one processing device to assess the plurality of candidate term life insurance policies based on predetermined criteria, the predetermined criteria comprising at least one of:
a total term of a candidate term life insurance policy;
a remaining term of a candidate term life insurance policy;
an amount of premiums paid into a candidate term life insurance policy;
a percentage of an amount of premiums paid into a term life insurance policy relative to a total amount of premiums that would be paid by an end date of the term life insurance policy;
an age of the policy holder; and
an age that the policy holder would be at the end date of the term life insurance policy.

4. The system of claim 1 wherein the proposed term life insurance policy exchange comprises:
an assignment of the term life insurance policy; and
a transfer of a cost basis of the term life insurance policy to the annuity.

5. The system of claim 1 wherein in obtaining approval of the proposed term life insurance policy exchange from the policy holder and an issuer of the annuity offer, the instruction further cause the at least one processing device to:
provide the proposed term life insurance policy exchange to a client device associated with the policy holder;
receive, from the client device associated with the policy holder, an indication to request approval from the issuer of the annuity offer;
provide the term life insurance policy data and the policy holder information corresponding to the selected term life insurance policy and the proposed term life insurance policy to a server associated with the issuer of the annuity offer;
receive, from the server associated with the issuer of the annuity offer, an approval of the proposed term life insurance policy exchange;
provide the approved term life insurance policy exchange to the client device associated with the policy holder; and
receive, from the client device associated with the policy holder, an endorsement of the approved term life insurance policy exchange.

6. The system of claim 1 wherein in facilitating the execution of the proposed term life insurance policy exchange, the instructions further cause the at least one processing device to:
interface with a server associated with an issuer of the selected term life insurance policy;
cause a transfer of the selected term life insurance policy from the issuer of the selected term life insurance policy to the issuer of the annuity offer;
interface with a server associated with the issuer of the annuity offer;
confirm the transfer of the selected term life insurance policy from the issuer of the selected term life insurance policy to the issuer of the annuity offer; and
cause the server associated with the issuer of the annuity offer to execute the term life insurance policy exchange.

7. The system of claim 1 wherein in facilitating the execution of the proposed term life insurance policy exchange, the instructions further cause the at least one processing device to:
interface with a server associated with an issuer of the selected term life insurance policy;
cause a transfer of the selected term life insurance policy from the issuer of the selected term life insurance policy to an entity associated with the system;
generate an annuity according to the approved term life insurance policy exchange, the annuity comprising:
an annuity premium paid by the policy holder; and
a cost basis transferred from the selected term life insurance policy; and
execute an assignment of the selected term life insurance policy.

8. The system of claim 7 wherein the instructions further cause the at least one processing device to:
interface with a server associated with the issuer of the annuity offer; and
transfer the generated annuity to the issuer of the annuity offer via the interface with the server associated with the issuer of the annuity offer.

9. The system of claim 1 wherein the instructions further cause the at least one processing device to determine an amount of a fee based on at least one of:
a percentage of a cost basis that is transferred from the selected term life insurance policy to the annuity as part of the term life insurance policy exchange; and
a percentage of an annuity premium payment being made into the annuity.

10. A method performed by at least one processor comprising hardware, the method comprising:
submitting a query to a database storing term life insurance policy data;
identifying a plurality of candidate term life insurance policies based on a result of the query;
selecting a term life insurance policy from the plurality of candidate term life insurance policies for offering a term life insurance policy exchange;
obtaining annuity offer data comprising requirements for an offer to purchase an annuity;
obtaining term life insurance policy data and policy holder information corresponding to the selected term life insurance policy;
determining that the policy holder information is a match for the requirements in the annuity offer data;
generating a proposed term life insurance policy exchange based at least in part on the determination that the policy holder information is a match for the requirements in the annuity offer data, the proposed term life insurance exchange comprising an exchange of the selected term life insurance policy for the annuity offer;
obtaining approval of the proposed term life insurance policy exchange from the policy holder and an issuer of the annuity offer; and
facilitating execution of the proposed term life insurance policy exchange.

11. The method of claim 10, wherein the query comprises at least one of:
a query for all term life insurance policies have a predetermined amount of term left;
a query for all term life insurance policies have a predetermined percentage of term left;
a query for all term life insurance policies having policy holders who are over a predetermined age;
a query for all term life insurance policies having a predetermined amount of premiums paid; and
a query for all term life insurance policies having a predetermined number of premium payments.

12. The method of claim 10 wherein selecting the term life insurance policy from the plurality of candidate term life insurance policies further comprises assessing the plurality of candidate term life insurance policies based on predetermined criteria, the predetermined criteria comprising at least one of:
a total term of a candidate term life insurance policy;
a remaining term of a candidate term life insurance policy;
an amount of premiums paid into a candidate term life insurance policy;
a percentage of an amount of premiums paid into a term life insurance policy relative to a total amount of premiums that would be paid by an end date of the term life insurance policy;
an age of the policy holder; and
an age that the policy holder would be at the end date of the term life insurance policy.

13. The method of claim 10 wherein the proposed term life insurance policy exchange comprises:
an assignment of the term life insurance policy; and
a transfer of a cost basis of the term life insurance policy to the annuity.

14. The method of claim 10 wherein obtaining approval of the proposed term life insurance policy exchange from the policy holder and an issuer of the annuity offer further comprises:
providing the proposed term life insurance policy exchange to a client device associated with the policy holder;
receiving, from the client device associated with the policy holder, an indication to request approval from the issuer of the annuity offer;
providing the term life insurance policy data and the policy holder information corresponding to the selected term life insurance policy and the proposed term life insurance policy to a server associated with the issuer of the annuity offer;
receiving, from the server associated with the issuer of the annuity offer, an approval of the proposed term life insurance policy exchange;
providing the approved term life insurance policy exchange to the client device associated with the policy holder; and
receiving, from the client device associated with the policy holder, an endorsement of the approved term life insurance policy exchange.

15. The method of claim 10 wherein facilitating the execution of the proposed term life insurance policy exchange further comprises:
interfacing with a server associated with an issuer of the selected term life insurance policy;
causing a transfer of the selected term life insurance policy from the issuer of the selected term life insurance policy to the issuer of the annuity offer;
interfacing with a server associated with the issuer of the annuity offer;
confirming the transfer of the selected term life insurance policy from the issuer of the selected term life insurance policy to the issuer of the annuity offer; and
causing the server associated with the issuer of the annuity offer to execute the term life insurance policy exchange.

16. The method of claim 10 wherein facilitating the execution of the proposed term life insurance policy exchange further comprises:
interfacing with a server associated with an issuer of the selected term life insurance policy;
causing a transfer of the selected term life insurance policy from the issuer of the selected term life insurance policy to an entity associated with the at least one processor;
generating an annuity according to the approved term life insurance policy exchange, the annuity comprising:
an annuity premium paid by the policy holder; and
a cost basis transferred from the selected term life insurance policy; and
executing an assignment of the selected term life insurance policy.

17. The method of claim 16 wherein the method further comprises:
interfacing with a server associated with the issuer of the annuity offer; and
transferring the generated annuity to the issuer of the annuity offer via the interface with the server associated with the issuer of the annuity offer.

18. The method of claim 16 wherein the method further comprises determining an amount of a fee based on at least one of:
a percentage of a cost basis that is transferred from the selected term life insurance policy to the annuity as part of the term life insurance policy exchange; and
a percentage of an annuity premium payment being made into the annuity.

19. A non-transitory computer-readable medium storing instructions that, when executed by at least one processor, cause the at least one processor to:
submit a query to a database storing term life insurance policy data;
identify a plurality of candidate term life insurance policies based on a result of the query;
select a term life insurance policy from the plurality of candidate term life insurance policies for offering a term life insurance policy exchange;
obtain annuity offer data comprising requirements for an offer to purchase an annuity;
obtain term life insurance policy data and policy holder information corresponding to the selected term life insurance policy;
determine that the policy holder information is a match for the requirements in the annuity offer data;
generate a proposed term life insurance policy exchange based at least in part on the determination that the policy holder information is a match for the requirements in the annuity offer data, the proposed term life insurance exchange comprising an exchange of the selected term life insurance policy for the annuity offer;
obtain approval of the proposed term life insurance policy exchange from the policy holder and an issuer of the annuity offer; and
facilitate execution of the proposed term life insurance policy exchange.

20. The non-transitory computer-readable medium of claim 18 wherein in facilitating the execution of the proposed term life insurance policy exchange, the instructions further cause the at least one processor to:
interface with a server associated with an issuer of the selected term life insurance policy;
cause a transfer of the selected term life insurance policy from the issuer of the selected term life insurance policy to the issuer of the annuity offer;
interface with a server associated with the issuer of the annuity offer;
confirm the transfer of the selected term life insurance policy from the issuer of the selected term life insurance policy to the issuer of the annuity offer; and
cause the server associated with the issuer of the annuity offer to execute the term life insurance policy exchange.
